(19) United States
(12) Patent Application Publication
(10) Pub. No.: US 2026/0251893 A1
(43) Pub. Date: Aug. 27, 2026

(54) OPTICAL ADAPTER DEVICE AND SURGICAL MICROSCOPE

(71) Applicant: ZUMAX MEDICAL CO., LTD., Jiangsu (CN)

(72) Inventors: Jilong WANG, Jiangsu (CN); Jiuqi XU, Jiangsu (CN); Xiaoguang YANG, Jiangsu (CN); Sheng GUAN, Jiangsu (CN); Tao QIU, Jiangsu (CN); Jianyue LI, Jiangsu (CN)

(21) Appl. No.: 18/870,512

(22) PCT Filed: Jul. 20, 2022
(86) PCT No.: PCT/CN2022/106649

§ 371 Date: Nov. 29, 2024

(30) Foreign Application Priority Data
May 30, 2022 (CN) 202210597672.X

(51) Int. Cl. G02B 21/18; G02B 21/00

(52) U.S. Cl. CPC G02B 21/18; G02B 21/0012

(57) ABSTRACT

An optical adapter device and a surgical microscope provided with the optical adapter device which includes a body housing and an optical lens group, two ends of the body housing are connected to a surgical microscope and a digital camera device, the body housing includes a first housing segment, a second housing segment, and a third housing segment, the first housing segment extends at least partially in the direction of a first axis; one end of the second housing segment is connected to the other end of the first housing segment, the second housing segment extends at least in the direction of a second axis; one end of the third housing segment is connected to the other end of the second housing segment, the third housing segment extends at least in the direction of a third axis, the first axis and the third axis intersect with the second axis, respectively.

### CROSS-REFERENCE TO RELATED APPLICATIONS

This application claims priority to PCT/CN2022/106649, filed on Jul. 20, 2022, which claims priority to Chinese Patent Application No. 202210597672.X, filed on May 30, 2022, both of which are hereby incorporated by reference in their entireties.

### TECHNICAL FIELD

The present disclosure belongs to the field of medical apparatus and instruments, and relates to an optical adapter device, and a surgical microscope provided with this optical adapter device.

### BACKGROUND

Microscope is a kind of precision optical instrument suitable for observing microscopic substances and has a wide range of applications in scientific research, medical and other fields. In microsurgery, a surgical microscope is an essential tool for doctors. Given the needs of clinical research, teaching, consultation, and dispute resolution, it is necessary to form clear imaging records of the operation process and results. The current commonly used solution is to add a splitter between the microscope body and the binocular tube, and connect to a digital device by adding an optical adapter device to the splitting branch. As shown in FIGS. 1 and 2, in existing surgical microscopes, the optical adapters 2′ are mostly L-shaped as a whole and are disposed on one or both sides of the microscope body 1′, in the figures, the upper portion of the microscope body 1′ is connected to a splitter 11′, optical adapters 2′ are connected on both sides of the splitter 11′, and digital camera devices 3′ are connected to the optical adapters 2′. When the splitter 11′ is connected to a digital camera, the optical adapter 2′ can only adjust the angle in the vertical direction and cannot rotate in the horizontal direction, which is not conducive to the assistant recording image data during the operation process, greatly affecting the operation efficiency and cannot meet the multi-scenario application requirements.

In practical operation, users often need to observe the images captured by digital devices in real time and control the digital devices to take photos or record videos. In most cases, due to the limitation of the operating position, users need to twist their heads or even leave their work position to observe the status of the digital devices, and cannot conveniently and quickly control the digital devices.

Refer to the patents with publication numbers of CN211123465U, it discloses a surgical microscope that integrates an existing splitter into the microscope body, where the binocular tube is connected to the front side of the microscope body, and the optical adapter is connected to the rear side of the microscope body, which is more conducive to the overall balance of the lens and allows the operator to conveniently observe the status of the digital devices. However, from the perspective of practical production and use, although this structure simplifies the overall structure of the surgical microscope outwardly, it completely changes the coaxial characteristics of the optical path in the body of the traditional microscope, and has great specificity, on the one hand, it greatly increases the complexity of the optical and mechanical structure of this microscope body and the difficulty of optical-mechanical assembly, which increases the production and manufacturing costs, and on the other hand, it seriously restricts the scalability of the microscope and cannot achieve modular connection.

Meanwhile, it has not disclosed the specific setting method and parameters of the imaging lens group in the optical path of the digital devices. Due to the fact that the adapter not only serves as a mechanical connection, but also plays a decisive role in the quality of optical imaging, the specific setting of its imaging lens group has a significant impact on the compensation and correction of optical aberrations such as spherical aberration, coma aberration, chromatic aberration, field curvature, and distortion. In addition, optical magnification, aperture, entrance and exit pupil matching, edge light vignetting, etc., all need to be comprehensively considered for different types of digital devices, and only through the reasonable setting of the imaging lens group can the digital device ultimately achieve better image quality.

Therefore, considering the existing technical problems mentioned above, it is necessary to provide a new technical solution.

### SUMMARY

The present disclosure provides an optical adapter device.

A first aspect provides an optical adapter device for connecting a surgical microscope and a digital camera device, comprising a body housing and an optical lens group arranged inside the body housing, one end of the body housing forming a first connection end for connecting with a splitter of the surgical microscope, and the other end of the body housing forming a second connection end for connecting with the digital camera device, wherein the body housing comprises a first housing segment, a second housing segment, and a third housing segment, one end of the first housing segment forms the first connection end, and the first housing segment extends at least partially in the direction of a first axis; one end of the second housing segment is connected to the other end of the first housing segment, and the second housing segment extends at least in the direction of a second axis; one end of the third housing segment is connected to the other end of the second housing segment, and the other end of the third housing segment forms the second connection end, the third housing segment extends at least in the direction of a third axis, and the first axis and the third axis intersect with the second axis, respectively.

For the above-mentioned technical solution, preferably, the first housing segment and the second housing segment are able to rotate relative to each other taking the first axis as the axis of rotation, and/or
the second housing segment and the third housing segment are able to rotate relative to each other taking the second axis as the axis of rotation. It enables the optical adapter device to rotate not only in the horizontal direction but also selectively in the vertical direction, while 360° rotation achieves observation at any angle.

For the above-mentioned technical solution, preferably, both the first axis and the third axis are perpendicular to the second axis.

For the above-mentioned technical solution, preferably, in at least one state of the body housing, the first housing segment and the third segment are both located on the same side as the second housing segment, and are C-shaped, that is, it allows for simultaneous observation in the eyepiece and the digital camera device. For the above-mentioned technical solution, preferably, the optical lens group comprises:
a lens group, located on at least one of the first axis, the second axis and the third axis;
a mirror group, the mirror group comprising a first mirror and a second mirror, the first mirror being located at the intersection of the first axis and the second axis, and the second mirror being located at the intersection of the second axis and the third axis.

Further preferably, the lens group comprises a first lens group located on the first axis, a second lens group located on the second axis, and a third lens group on the third axis.

In an implementation of the present application, some parameters of the first lens group, the second lens group and the third lens group are selected as follows: the focal length for of the first lens group satisfies: 150 mm<f_{G1}<300 mm,
the focal length f_{G2} of the second lens group satisfies: 0.5<f_{G2}/f_{G1}<2,
the focal length f_{G3} of the third lens group satisfies: 10<f_{G1}/f_{G3}<30.

The first lens group is a doublet lens group with positive focal power, and

$$\frac{\vert {R}_{1} \vert}{{φ}_{1} / 2} < 20 ,$$

where R₁ is the curvature radius of the cemented surface of the first lens group, and φ₁ is the effective pore size of the cemented surface;
the second lens group is a doublet lens group with positive focal power, and

$$\frac{\vert {R}_{2} \vert}{{φ}_{2} / 2} < 15 ,$$

where R₂ is the curvature radius of the cemented surface of the second lens group, and φ₂ is the effective pore size of the cemented surface;
the third lens group comprises a doublet lens group with positive focal power and a single lens, and

$$\frac{\vert {R}_{3} \vert}{{φ}_{3} / 2} < 10 ,$$

where R₃ is the curvature radius of the cemented surface of the doublet lens group in the third lens group, and φ₃ is the effective pore size of the cemented surface.

Further preferably, the first lens group is disposed in the first housing segment; the first mirror and the second lens group are disposed in the second housing segment; the second mirror and the third lens group are disposed in the third housing segment.

In an implementation of the present application, some parameters of the first lens group, the second lens group and the third lens group are selected as follows:
the focal length f_{G1} of the first lens group satisfies: −300 mm<f_{G1}<−150 mm,
the focal length f_{G2} of the second lens group satisfies: −2<f_{G2}/f_{G1}<−0.2,
the focal length f_{G3} of the third lens group satisfies: 2<f_{G1}/f_{G3}<20.

The first lens group is a doublet lens group with negative focal power, and

$$\frac{\vert {R}_{1} \vert}{{φ}_{1} / 2} < 8 ,$$

where R₁ is the curvature radius of the cemented surface of the first lens group, and φ₁ is the effective pore size of the cemented surface;
the second lens group is a doublet lens group with positive focal power, and

$$\frac{\vert {R}_{2} \vert}{{φ}_{2} / 2} < 15 ,$$

where R₂ is the curvature radius of the cemented surface of the second lens group, and φ₂ is the effective pore size of the cemented surface;
the third lens group is a doublet lens group with negative focal power, and

$$\frac{\vert {R}_{3} \vert}{{φ}_{3} / 2} < 11 ,$$

where R₃ is the curvature radius of the cemented surface of the doublet lens group in the third lens group, and φ₃ is the effective pore size of the cemented surface.

Further preferably, the first lens group is disposed in the first housing segment; the second lens group, the first mirror and the third lens group are disposed in the second housing segment; the second mirror is disposed in the third housing segment.

For the above-mentioned technical solution, preferably, the optical lens group comprises an image steering lens group, the image steering lens group is located on the second axis, and is able to rotate taking the second axis as the axis of rotation, and by adjusting the direction of an optical image imaged on a photosensitive unit of the digital camera device through the image steering lens group, different observation requirements are met.

The image steering lens group may be selected from a Dove prism, a Pechan prism, and a right-angle prism, etc.

Further preferably, the second housing segment is provided with a rotating portion for rotating the image steering lens group, the image steering lens group is connected to the rotating portion, the rotation of the image steering lens group is facilitated by operating the rotating portion, and the rotating portion may be a rotating joint on the body housing, or the like.

For the above-mentioned technical solution, preferably, the body housing is comprised of the first housing segment, the second housing segment and the third housing segment, which enables the optical adapter device to meet structural requirements while also making the structure the simplest.

A second aspect provides a surgical microscope comprises a microscope body and an optical adapter device, the microscope body comprises a microscope lens body, a splitter and an eyepiece, the splitter is connected to the microscope lens body, the eyepiece and the optical adapter device are respectively connected to the splitter, and the optical adapter device is the optical adapter device mentioned above.

For the above-mentioned technical solution, preferably, the surgical microscope further comprises a digital camera device, and the digital camera device is selected from a smart phone, a camera, and a tablet computer.

Further preferably, in at least one state of the surgical microscope, the eyepiece and the digital camera device face the same side of the microscope lens body.

For the above-mentioned technical solution, preferably, the optical adapter device is detachably connected to the splitter, so the optical adapter device or the digital camera device can be selected connected.

For the above-mentioned technical solution, preferably, the splitter comprises a splitter housing and a splitter lens group arranged inside the splitter housing, the splitter housing has a lens body connection end, an eyepiece connection end and an adapter connection end, the eyepiece connection end faces the front side of the microscope lens body, the adapter connection end faces the rear side of the microscope lens body, the microscope lens body is connected to the lens body connection end, the eyepiece is connected to the eyepiece connection end, and the optical adapter device is connected to the adapter connection end.

Further preferably, the splitter lens group comprises a combination of a pentaprism and a Schmidt prism, or a combination of a cubic prism and a pentaprism, or a combination of a cubic prism, a pentaprism and a rhombic prism, or a combination of a cubic prism, a pentaprism and a right-angle prism, or a combination of a cubic prism, a right-angle roof prism and a right-angle prism.

Due to the use of the above technical solutions, the present disclosure has the following advantages over the conventional art:
1. The optical adapter device of the present disclosure can be adapted to splitters of different structures and is suitable for a wider range of microscope lens bodies;
2. The optical adapter device of the present disclosure can be applied to various digital devices, allowing for clearer observation and recording of images while being flexible in operation, thereby improving diagnostic efficiency;
3. The optical adapter device of the present disclosure is modularly produced and assembled, with a simple structure, good scalability, and low cost.

### BRIEF DESCRIPTION OF THE DRAWINGS

FIGS. 1 and 2 are schematic diagrams of a surgical microscope when connected to an optical adapter device in the conventional art;

FIG. 3 is a schematic sectional view of a surgical microscope in an embodiment;

FIG. 4 is a schematic diagram of the relative rotation of a first housing segment and a second housing segment in an embodiment;

FIG. 5 is a schematic diagram of the relative rotation of a second housing segment and a third housing segment in an embodiment;

FIGS. 6-8 are schematic diagrams of rotating the direction of an optical image on a photosensitive unit of the digital camera device through the image steering lens group in an embodiment;

FIG. 9 is a schematic three-dimensional diagram of Embodiment 1 of the surgical microscope;

FIG. 10 is a schematic sectional view of Embodiment 1 of the surgical microscope;

FIG. 11 shows the optical principle diagram of Embodiment 1 of the surgical microscope;

FIG. 12 is a schematic three-dimensional diagram of Embodiment 2 of the surgical microscope;

FIG. 13 is a schematic sectional view of Embodiment 2 of the surgical microscope;

FIG. 14 shows the optical principle diagram of Embodiment 2 of the surgical microscope;

FIGS. 15-19 are schematic diagrams of a splitter lens group in an embodiment;

FIG. 20 is a schematic diagram of the radius and thickness in the optical structure parameters of Embodiment 1 and Embodiment 2.

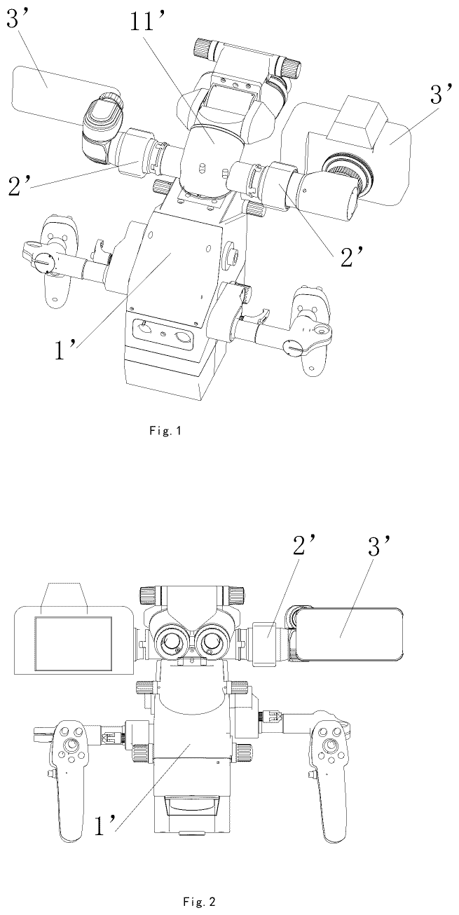

In the above accompanying drawings:
1. microscope body; 10. microscope lens body; 110. splitter housing; 10a. lens body connection end; 10b, eyepiece connection end; 110c, adapter connection end; 11a, pentaprism; 111b, Schmidt prism; 111c, cubic prism; 111d, pentaprism; 111e, rhombic prism; 111f, right-angle prism; 111g, right-angle roof prism; 12. eyepiece;
2. optical adapter device; 20. body housing; 20a. first connection end; 20b. second connection end; 200. first housing segment; 201. second housing segment; 202. third housing segment; 206. rotating portion; 210. first lens group; 211. second lens group; 212. third lens group; 213. first mirror; 214. second mirror; 215. image steering lens group;
3. digital camera device; 30. smart phone; 31. camera;
a. first axis; b. second axis; c. third axis;
1′. microscope lens body; 11′. splitter; 2′. optical adapter device; 3′. digital camera device.

### DESCRIPTION OF EMBODIMENTS

The technical solutions of the present disclosure will be described clearly and completely below with reference to the accompanying drawings. Apparently, the described embodiments are merely some of rather than all of the embodiments of the present disclosure. All other embodiments obtained by those of ordinary skill in the art without creative efforts based on the embodiments of the present disclosure shall fall within the protective scope of the present disclosure.

In the description of the present disclosure, it should be noted that the orientations or positional relationships indicated by the terms “center”, “upper”, “lower”, “left”, “right”, “vertical”, “horizontal”, “inner”, “outer”, etc. are based on those shown in the accompanying drawings, are only for the convenience of describing the present disclosure and simplifying the description, rather than indicating or implying that the indicated device(s) or element(s) must have a specific orientation, be constructed and operated in a specific orientation, and therefore should not be construed as a limitation of the present disclosure. Furthermore, the terms “first”, “second”, “third” and are used for descriptive purposes only and should not be construed to indicate or imply relative importance.

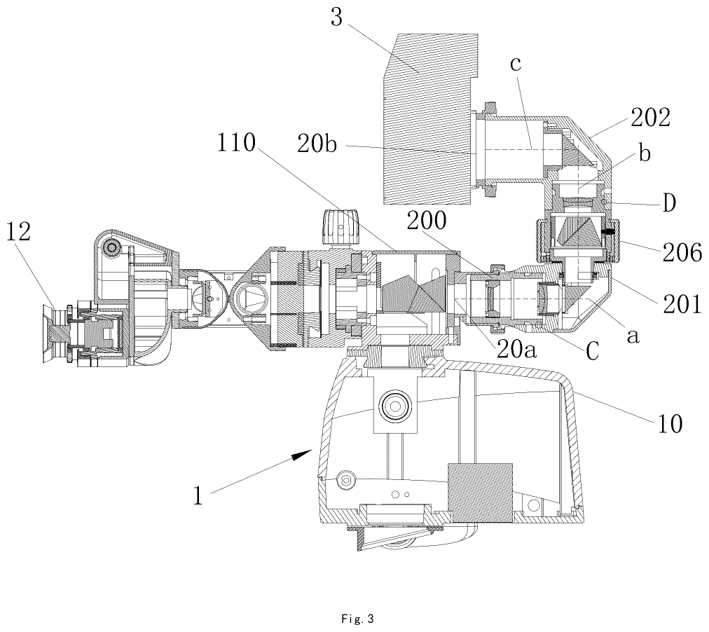

A surgical microscope as shown in FIGS. 3, 10 and 13, comprises a microscope body 1, an optical adapter device 2, and a digital camera device 3. Wherein, the optical adapter device 2 and the digital camera device 3 may be used as accessories for a surgical microscope, and be detachably connected to the microscope body 1 and selectively used according to needs.

The microscope body 1, the optical adapter device 2, and the digital camera device 3 are described in detail below.

The part of the microscope body 1:

The microscope body 1 comprises a microscope lens body 10, a splitter and an eyepiece 12, the splitter is connected to the microscope lens body 10, and the eyepiece 12 and the optical adapter device 2 are respectively connected to the splitter. The eyepiece 12 adopts a conventional binocular tube.

In this embodiment, the splitter is not integrated into the microscope lens body 10, and comprises a splitter housing 110 and a splitter lens group arranged inside the splitter housing 110. Wherein:

The splitter housing 110 has a lens body connection end 110a, an eyepiece connection end 110b and an adapter connection end 110c, the lens body connection end 110a is located at the bottom of the splitter housing 110, the eyepiece connection end 110b faces the front side of the microscope lens body 10, namely it is located at the front of the splitter housing 110, the adapter connection end 110c faces the rear side of the microscope lens body 10, namely it is located at the rear of the splitter housing 110, the microscope lens body 10 is connected to the lens body connection end 110a, the eyepiece 12 is connected to the eyepiece connection end 110b, the optical adapter device 2 is connected to the adapter connection end 110c, and in a desired mode, the optical adapter device 2 is detachably connected to the adapter connection end 110c. The eyepiece 12 and the optical adapter device 2 are respectively located on opposite front and rear sides of the microscope lens body 10, ensuring front-rear structural balance.

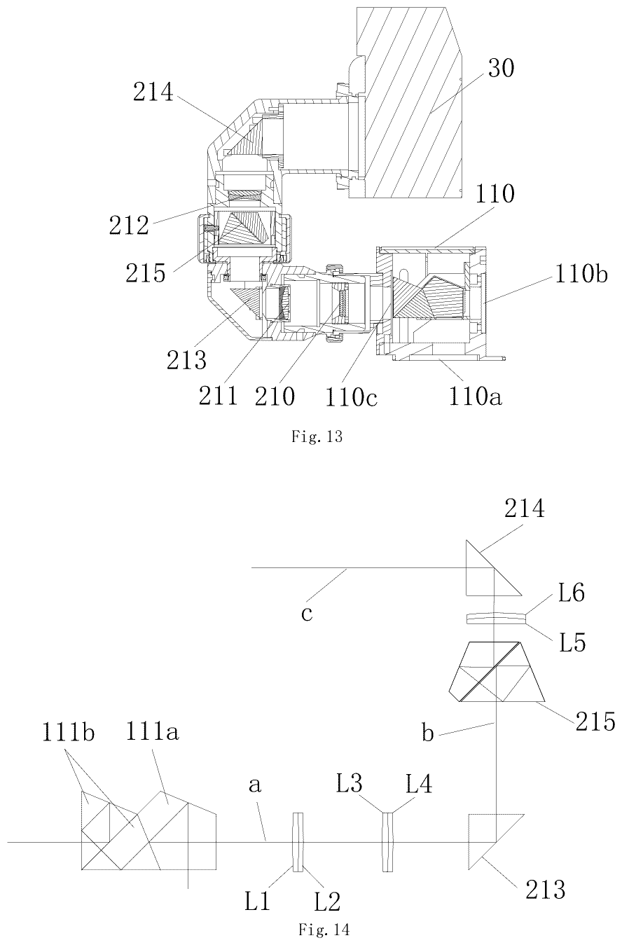

An implementation of the splitter lens group in this embodiment is shown in FIGS. 11 and 14: the splitter lens group comprises pentaprisms 111a and Schmidt prisms 111b, specifically one pentaprism 111a and two Schmidt prisms 111b. The real image light of an object enters the microscope lens body 10 through a large object lens group, passes through the optical elements inside the microscope lens body 10 such as the zoom system and reaches the pentaprism 111a, then, using one of the reflecting surfaces of the pentaprism 111a as the splitting surface, a part of the light is directly reflected into the eyepiece 12, while another part is refracted into the Schmidt prisms 111b, and finally enters the optical adapter device 2 after turning processes in the Schmidt prisms 111b. In this implementation, the light rays split by the splitter lens group are located at the same height.

Another implementation of the splitter lens group in this embodiment is shown in FIG. 15: the splitter lens group comprises a cubic prism 111c and a pentaprism 111d, and in the height direction, the pentaprism 111d is located above the cubic prism 111c, the cubic prism 111c is composed of two right-angle prisms, and the inclined surfaces of the two right-angle prisms are adhered to form a splitting surface. In the light rays split by the cube prism 111c, a part of the light enters the optical adapter device 2, while the other part is reflected by the pentaprism 111d and enters the eyepiece 12. Compared this implementation with that in FIG. 14, this implementation has a relatively lower processing cost due to the use of the commonly used cubic prism 111c for splitting; at the same time, it avoids the long optical path caused by multiple reflections in the Schmidt prism 111b, which is beneficial for reducing the vignetting of the camera light path; at the same time, the cubic prism 111c is located below the pentaprism 111d, which fully utilizes the air gap of the original structure, shortens the optical path, and reduces the vignetting of the observation light path. In this implementation, the light rays split by the splitter lens group will form a height difference, and the height of the light entering the eyepiece 12 will be higher than the height of the light entering the optical adapter device 2.

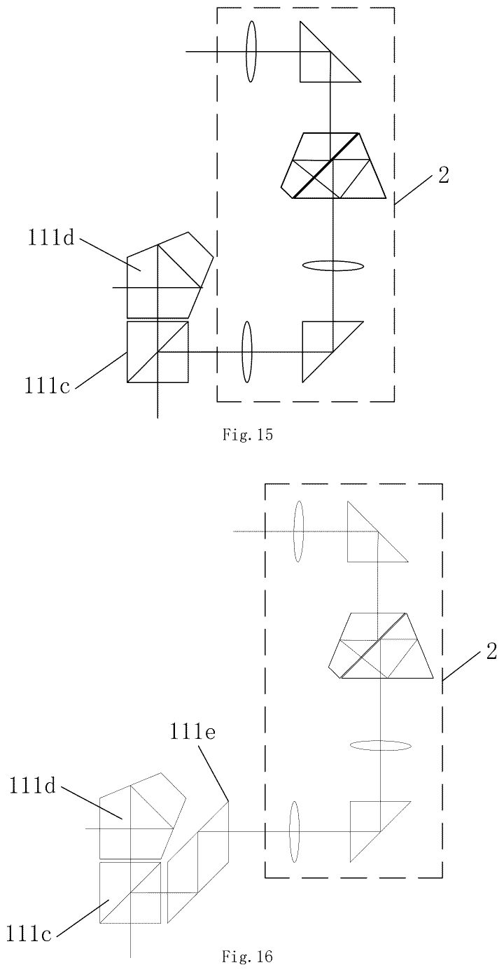

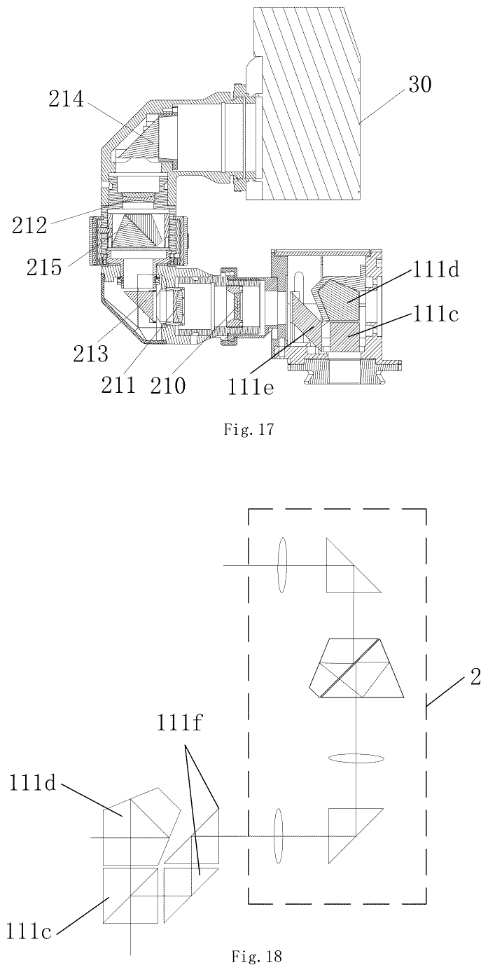

Another implementation of the splitter lens group in this embodiment is shown in FIGS. 16 and 17: the splitter lens group comprises a cubic prism 111c, a pentaprism 111d and a rhombic prism 111e, and in the height direction, the pentaprism 111d is located above the cubic prism 111c, the cubic prism 111c is composed of two right-angle prisms, the inclined surfaces of the two right-angle prisms are adhered to form a splitting surface, and the rhombic prism 111e is located between the cubic prism 111c and the optical adapter device 2. In the light rays split by the cube prism 111c, a part of the light enters the rhombic prism 111e and then the optical adapter device 2, while the other part is reflected by the pentaprism 111d and enters the eyepiece 12. Compared with the mode shown in FIG. 15, this implementation raises the optical axis of the imaging light path by adding a rhombic prism 111e, avoiding mechanical interference, at the same time, it utilizes the air gap of the original structure, resulting in a compact optical path and low processing costs, and in this implementation, the light split by the splitter lens group is also located at the same height.

Another implementation of the splitter lens group in this embodiment is shown in FIG. 18: the splitter lens group comprises a cubic prism 111c, a pentaprism 111d and two right-angle prisms 111f, and in the height direction, the pentaprism 111d is located above the cubic prism 111c, the cubic prism 111c is composed of two right-angle prisms, the inclined surfaces of the two right-angle prisms are adhered to form a splitting surface, the two right-angle prisms 111f form a rhombic prism 111e, and in the light split by the cubic prism 111c, a part of the light passes through the two right-angle prisms 111f successively and then enters the optical adapter device 2, while the other part is reflected by the pentaprism 111d and enters the eyepiece 12. Compared this implementation with that shown in FIG. 16, the rhombic prism 111e is replaced by the right-angle prism 111f, and according to the structural requirements, the height of the optical axis of the imaging light path may be adjusted by adjusting the spacing between the two right-angle prisms 111f, at the same time, since the right-angle prisms 111f can be independently adjusted, which is convenient for optical installation and calibration. In this implementation, the optical axis is adjustable in the height direction.

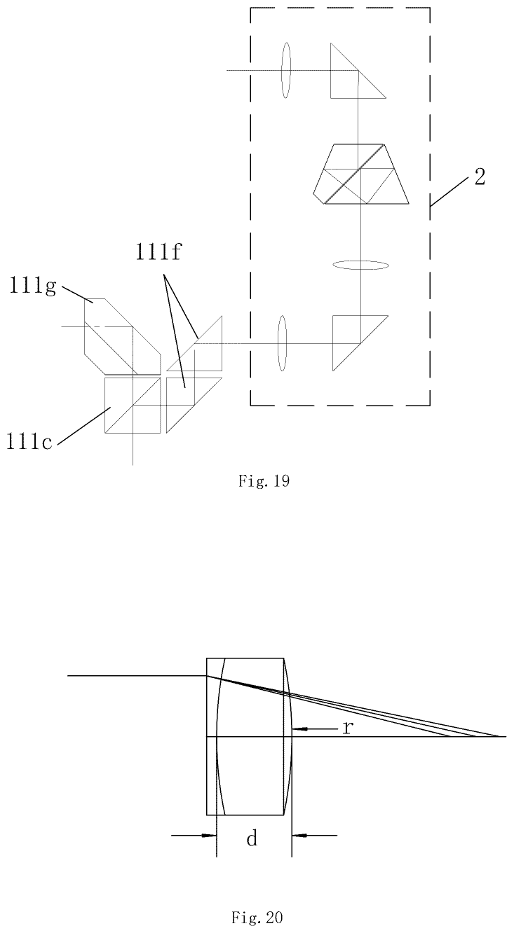

Another implementation of the splitter lens group in this embodiment is shown in FIG. 19: the splitter lens group comprises a cubic prism 111c, a right-angle roof prism 111g and two right-angle prisms 111f, and in the height direction, the right-angle roof prism 111g is located above the cubic prism 111c, the cubic prism 111c is composed of two right-angle prisms, the inclined surfaces of the two right-angle prisms are adhered to form a splitting surface, and the two right-angle prisms 111f form a rhombic prism 111e. In the light rays split by the cube prism 111c, a part of the light passes through the two right-angle prisms 111f successively and then enters the optical adapter device 2, while the other part is reflected by the right-angle roof prism 111g and enters the eyepiece 12. Compared this implementation with that shown in FIG. 18, the internal optical path of the right-angle roof prism 111g is shortened by about half compared to the pentaprism 111d, which is more conducive to reducing the vignetting of the observation light path, and at the same time, the two internal reflections avoid the mirror phenomenon, and the image is rotated 180 degrees, which can remove the inverting prism in the optical path of the subsequent binocular tube and lower the overall cost. In this implementation, the optical axis is adjustable in the height direction.

The part of the optical adapter device 2:

The optical adapter device 2 comprises a body housing 20 and an optical lens group arranged inside the body housing 20, one end of the body housing 20 forms a first connection end 20a for connecting with the splitter of the microscope body 1, and the other end of the body housing 20 forms a second connection end 20b for connecting with the digital camera device 3.

Furthermore, the body housing 20 has:
a first housing segment 200: one end of the first housing segment 200 forms a first connection end 20a, and the first housing segment 200 extends at least partially in the direction of a first axis a;
a second housing segment 201, one end of the second housing segment 201 being connected to the other end of the first housing segment 200, and the second housing segment 201 extending at least in the direction of a second axis b;
a third housing segment 202, one end of the third housing segment 202 being connected to the other end of the second housing segment 201, the other end of the third housing segment 202 forming a second connection end 20b, and the third housing segment 202 extending at least in the direction of a third axis c.

In this embodiment, the body housing is comprised of the first housing segment 200, the second housing segment 201 and the third housing segment 202, namely a three-segment structure, which enables the optical adapter device to meet structural requirements while also making the structure the simplest.

The first axis a and the third axis c intersect with the second axis b, respectively. In this embodiment, the first axis a and the third axis c are both perpendicular to the second axis b, the first axis a and the third axis c extend horizontally, while the second axis b extends vertically, and in at least one state of the body housing 20, the first housing segment 200 and the third housing segment 202 are located on the same side of the second housing segment 201, and is C-shaped, as shown in FIG. 3.

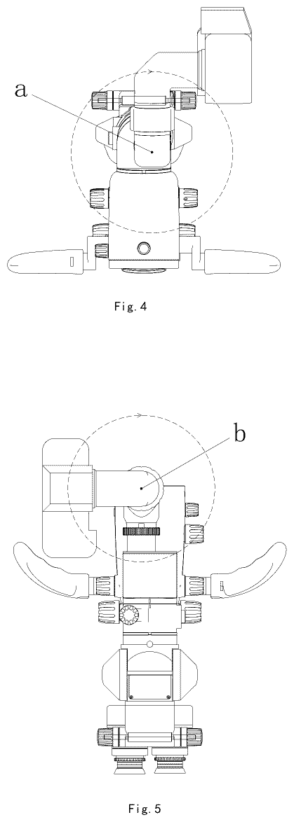

In this embodiment, the first housing segment 200 and the second housing segment 201 may rotate relative to each other with the first axis a as the axis of rotation, and the second housing segment 201 and the third housing segment 202 may rotate relative to each other with the second axis b as the axis of rotation, so that the optical adapter device may rotate not only in the horizontal direction but also in the vertical direction, as shown in FIGS. 4 and 5. In order to facilitate the implementation of the rotation mode between the housings, the rotation positions of the first housing segment 200 and the second housing segment 201 are shown at Point C in FIG. 3, and the rotation positions of the second housing segment 201 and the third housing segment 202 are shown at Point D in FIG. 3.

In addition, in at least one state of the surgical microscope, the eyepiece 12 and digital camera device 3 face the same side of the microscope lens body 10, so that while observing the eyepiece 12, the image on the digital camera device 3 may also be observed.

In this way, the digital camera device 3 may rotate in the horizontal and vertical directions through the optical adapter device (without interfering with the microscope lens body), to observe intraoperative images 360°, and adjust the direction of an image in the digital camera device 3 through the rotating portion 206, where the direction of the image may also be adjusted 360°.

The optical lens group comprises a lens group, a mirror group, and an image steering lens group 215. In particular,

The lens group is located on at least one of the first axis a, the second axis b and the third axis c.

The mirror group comprises a first mirror 213 and a second mirror 214, the first mirror 213 is located at the intersection of the first axis a and the second axis b, and the second mirror 214 is located at the intersection of the second axis b and the third axis c; all mirror groups shown in the figures adopt right-angle prisms.

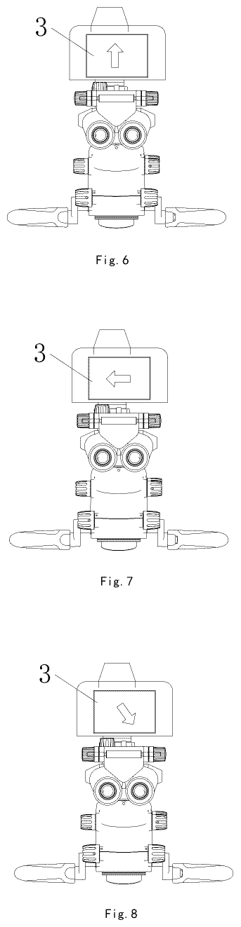

The image steering lens group 215 is located on the second axis b, and may rotate taking the second axis b as the axis of rotation, and by adjusting the direction of an image imaged on a photosensitive unit of the digital camera device 3 through the image steering lens group 215, different observation requirements are met, as shown in FIGS. 6-8. The image steering lens group 215 may be selected from a Dove prism, and a Pechan prism, etc., and the image steering lens group 215 shown is a Pechan prism.

This embodiment provides an implementation of rotating the image steering lens group 215, the body housing 20 is provided with a rotating portion 206 for rotating the image steering lens group 215, the image steering lens group 215 is connected to the rotating portion 206, the rotation of the image steering lens group 215 is facilitated by operating the rotating portion 206, and the rotating portion 206 may be a rotating joint on the body housing 20, or the like.

In addition, the optical lens group may also add one or more of variable diaphragms, filters, and polarizers according to the selection.

The part of the digital camera device 3:

The digital camera device 3 is selected from a smart phone 30, a camera 31 and a tablet computer. The digital camera device 3 may be connected to the second connection end 20b of the body housing 20 by tightening the locking ring or magnetic attraction.

According to the different types of digital camera device 3, the optical lens group of the optical adapter device will have different implementation methods, and two implementations of adopting the smart phone 30 and the camera 31 used for the digital camera device 3 are explained specifically below.

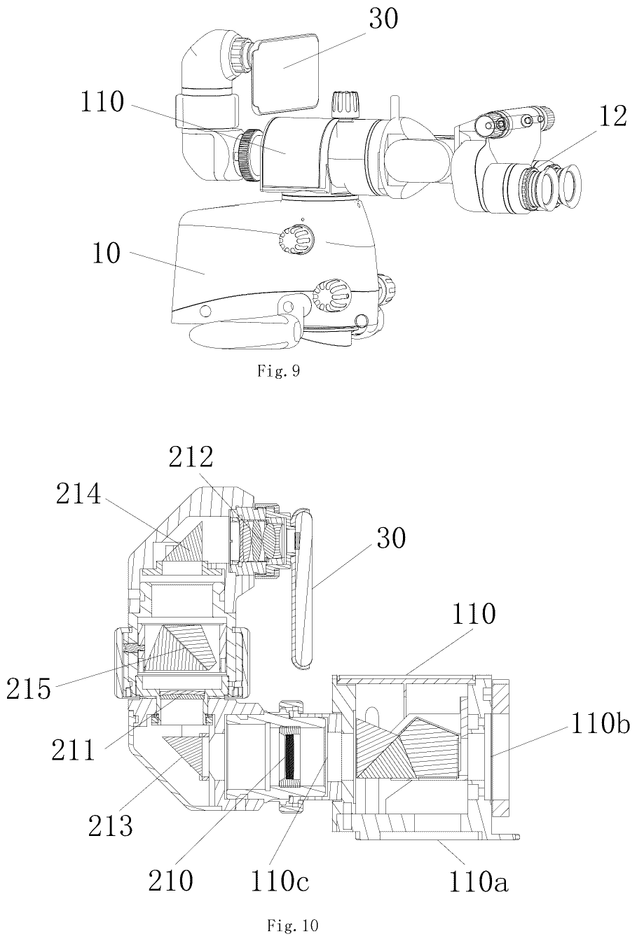

The digital camera device 3 as shown in FIGS. 9-11 adopts a smart phone 30, then,

The lens group comprises a first lens group 210 located on the first axis a, a second lens group 211 located on the second axis b, and a third lens group 212 on the third axis c.

The optical lens group is disposed as follows, the first lens group 210 is disposed in the first housing segment 200; the first mirror 213 and the second lens group 211 are disposed in the second housing segment 201; the second mirror 214 and the third lens group 212 are disposed in the third housing segment 202.

The first lens group 210 is a doublet lens group with positive focal power, comprising two lenses L1 and L2 (faces Nos. 1-3) starting from the object side; the second lens group 211 is a doublet lens group with positive focal power, comprising two lenses L3 and L4 (faces Nos. 6-8) starting from the object side; the third lens group 212 is a doublet lens group with positive focal power and a single lens, comprising three lenses L5, L6 and L7 (faces Nos. 13-17) starting from the object side.

Some parameters of the first lens group 210, the second lens group 211 and the third lens group 221 are selected as follows:
the focal length f_{G1} of the first lens group satisfies: 150 mm<f_{G1}<300 mm,
the focal length f_{G2} of the second lens group satisfies: 0.5<f_{G2}/f_{G1}<2,
the focal length f_{G3} of the second lens group satisfies: 10<f_{G1}/f_{G3}<30,

$$\frac{\vert {R}_{1} \vert}{{φ}_{1} / 2} < 20 ,$$

where R₁ is the curvature radius of the cemented surface of the first lens group, and φ₁ is the effective pore size of the cemented surface,

$$\frac{\vert {R}_{2} \vert}{{φ}_{2} / 2} < 15 ,$$

where R₂ is the curvature radius of the cemented surface of the second lens group, and is the effective pore size of the cemented surface,

$$\frac{\vert {R}_{3} \vert}{{φ}_{3} / 2} < 10 ,$$

where R₃ is the curvature radius of the cemented surface of the doublet lens group in the third lens group, and φ₃ is the effective pore size of the cemented surface.

Table 1 shows specific parameter examples of optical structures:

| | Face | Radius | Thickness | | |
|---|---|---|---|---|---|
| Lens group | No. | (mm) | (mm) | Nd | Vd |
| First lens | 1 | 150 | 2 | 1.4338 | 94.996 |
| group | 2 | −147.57 | 1.5 | 1.8467 | 23.78 |
| | 3 | −258.8 | 30 | | |
| First mirror | 4 | Infinity | 17 | 1.5168 | 64.167 |
| | 5 | Infinity | 13 | | |
| Second lens | 6 | Infinity | 2 | 1.4338 | 94.996 |
| group | 7 | −74.05 | 1.5 | 1.8467 | 23.78 |
| | 8 | −85 | 14 | | |
| Image steering | 9 | Infinity | — | | |
| lens group | 10 | Infinity | 24 | | |
| Second mirror | 11 | Infinity | 17 | 1.5168 | 64.167 |
| | 12 | Infinity | 14 | | |
| Third lens | 13 | 56.89 | 6 | 1.4338 | 94.996 |
| group | 14 | −15.642 | 0.5 | | |
| | 15 | 12.489 | 5.5 | 1.4338 | 94.996 |
| | 16 | −13.656 | 1.5 | 1.8467 | 23.78 |
| | 17 | −25.52 | — | | |

In the mirror group, the first mirror 213 is located at the intersection of the first axis a and the second axis b, and the second mirror 214 is located at the intersection of the second axis b and the third axis c.

The image steering lens group 215 is located on the second axis b, and may rotate taking the second axis b as the axis of rotation, and the second lens group 211 and the image steering lens group 215 are disposed on the second axis b in the direction of the light ray.

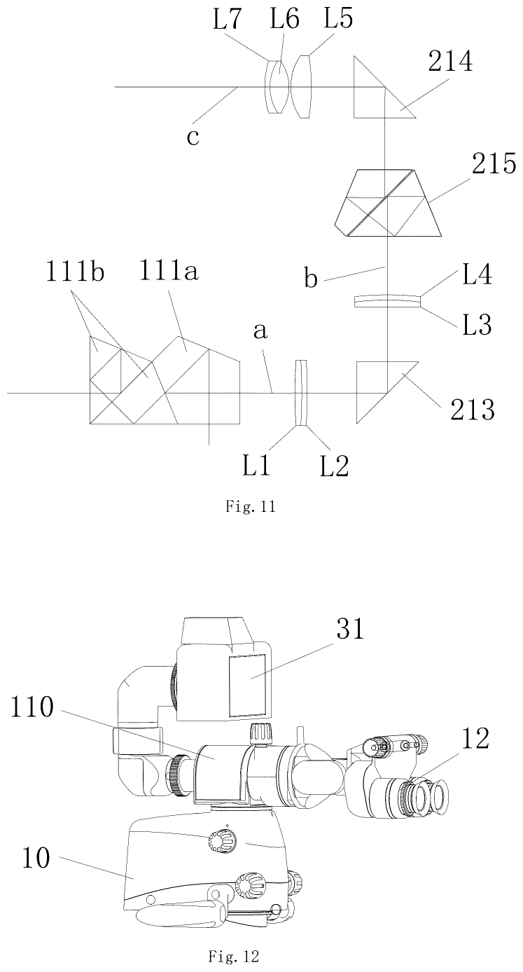

The digital camera device 3 as shown in FIGS. 12-14 adopts a camera 31, then,

The lens group comprises a first lens group 210 and a second lens group 211 located on the first axis a, and a third lens group 212 located on the second axis b, and the first lens group 210 and the second lens group 211 are disposed in the direction of the light ray.

The optical lens group is disposed as follows, the first lens group 210 is disposed in the first housing segment 200; the second lens group 211, the first mirror 213 and the third lens group 212 are disposed in the second housing segment 201; the second mirror 214 is disposed in the third housing segment 202.

The first lens group 210 is a doublet lens group with negative focal power, comprising two lenses L1 and L2 (faces Nos. 1-3) starting from the object side; the second lens group 211 is a doublet lens group with positive focal power, comprising two lenses L3 and L4 (faces Nos. 4-6) starting from the object side; the third lens group is a doublet lens group with negative focal power, comprising two lenses L5 and L6 (faces Nos. 14-16) starting from the object side.

Some parameters of the first lens group 210, the second lens group 211 and the third lens group 221 are selected as follows:
the focal length f_{G1} of the first lens group satisfies: −300 mm<f_{G1}<−150 mm,
the focal length f_{G2} of the second lens group satisfies: −2<f_{G2}/f_{G1}<−0.2,
the focal length f_{G3} of the third lens group satisfies: 2<f_{G1}/f_{G3}<20,

$$\frac{\vert {R}_{1} \vert}{{φ}_{1} / 2} < 8 ,$$

where R₁ is the curvature radius of the cemented surface of the first lens group, and φ₁ is the effective pore size of the cemented surface,

$$\frac{\vert {R}_{2} \vert}{{φ}_{2} / 2} < 15 ,$$

where R₂ is the curvature radius of the cemented surface of the second lens group, and φ₂ is the effective pore size of the cemented surface,

$$\frac{\vert {R}_{3} \vert}{{φ}_{3} / 2} < 11 ,$$

where R₃ is the curvature radius of the cemented surface of the doublet lens group in the third lens group, and φ₃ is the effective pore size of the cemented surface.

Table 2 shows specific parameter examples of optical structures:

| | Face | Radius | Thickness | | |
|---|---|---|---|---|---|
| Lens group | No. | (mm) | (mm) | Nd | Vd |
| First lens | 1 | −166 | 2 | 1.516 | 64.2125 |
| group | 2 | 68 | 1.5 | 1.6486 | 55.4857 |
| | 3 | −258.8 | 30 | | |
| Second lens | 4 | 100 | 4 | 1.6274 | 53.9285 |
| group | 5 | −60 | 2 | 1.6131 | 60.5244 |
| | 6 | −170 | 15 | | |
| First mirror | 7 | Infinity | 17 | 1.5168 | 64.167 |
| | 8 | Infinity | 13 | | |
| Image steering | 12 | Infinity | — | | |
| lens group | 13 | Infinity | 24 | | |
| Third lens | 14 | −88 | 2 | 1.6274 | 53.9285 |
| group | 15 | 69 | 3 | 1.6131 | 60.5244 |
| | 16 | −110 | 25 | | |
| Second mirror | 17 | Infinity | 17 | 1.5168 | 64.167 |
| | 18 | Infinity | — | | |

In the mirror group, the first mirror 213 is located at the intersection of the first axis a and the second axis b, and the second mirror 214 is located at the intersection of the second axis b and the third axis c;

The image steering lens group 215 is located on the second axis b, and may rotate taking the second axis b as the axis of rotation, and the image steering lens group 215 and the second lens group 211 are disposed on the second axis b in the direction of the light ray.

As shown in FIG. 20, and in Table 1 and Table 2,

The radius r is the curvature radius of the lens surface,

The thickness d is the center thickness of the lens,

Nd is the refractive index of d light (wavelength 589.3 nm) in an optical glass,

Explanation of Vd: Due to the difference in refractive index of the same transparent medium for light of different wavelengths, and the fact that white light is composed of various colored lights of different wavelengths, the special phenomenon of dispersion occurs when transparent materials refract white light, the Abbe number is an index used to represent the dispersion ability of a transparent medium, and the commonly used reference base is the central dispersion, which is the difference in refractive index between blue light and red light.

$$Abbe number V d = ( n d - 1 ) / ( n F - n C ) ,$$

nd, nF, and nC are the refractive indices of D light, F light, and C light, respectively.

D light—yellow light, 589.3 nm, D line in sodium spectrum,

F light—blue light, 486.1 nm, F line in hydrogen spectrum,

C light—red light, 656.3 nm, C line in hydrogen spectrum.

The embodiments described above are only for illustrating the technical concepts and features of the present disclosure, and are intended to make those skilled in the art being able to understand the present disclosure and thereby implement it, and should not be concluded to limit the protective scope of this disclosure. Any equivalent variations or modifications according to the spirit of the present disclosure should be covered by the protective scope of the present disclosure.

1. An optical adapter device, for connecting a surgical microscope and a digital camera device, comprising a body housing and an optical lens group arranged inside the body housing, one end of the body housing forming a first connection end for connecting with a splitter of the surgical microscope, and the other end of the body housing forming a second connection end for connecting with the digital camera device, wherein the body housing comprises a first housing segment, a second housing segment, and a third housing segment,
one end of the first housing segment forms the first connection end, and the first housing segment extends at least partially in the direction of a first axis;
one end of the second housing segment is connected to the other end of the first housing segment, and the second housing segment extends at least in the direction of a second axis;
one end of the third housing segment is connected to the other end of the second housing segment, and the other end of the third housing segment forms the second connection end, and the third housing segment extends at least in the direction of a third axis,
the first axis and the third axis intersect with the second axis, respectively.

2. The optical adapter device according to claim 1, wherein the first housing segment and the second housing segment are able to rotate relative to each other taking the first axis as the axis of rotation, and/or, the second housing segment and the third housing segment are able to rotate relative to each other taking the second axis as the axis of rotation.

3. (canceled)

4. The optical adapter device according to claim 1, wherein the first axis and the third axis are perpendicular to the second axis.

5. The optical adapter device according to claim 1, wherein in at least one state of the body housing, the first housing segment and the third segment are both located on the same side as the second housing segment, and are C-shaped.

6. The optical adapter device according to claim 1, wherein the optical lens group comprises:
a lens group, located on at least one of the first axis, the second axis and the third axis;
a mirror group, the mirror group comprising a first mirror and a second mirror, the first mirror being located at the intersection of the first axis and the second axis, and the second mirror being located at the intersection of the second axis and the third axis.

7. The optical adapter device according to claim 6, wherein the lens group comprises a first lens group located on the first axis, a second lens group located on the second axis, and a third lens group on the third axis.

8. The optical adapter device according to claim 7, wherein
the focal length f_{G1} of the first lens group satisfies 150 mm<f_{G1}<300 mm,
the focal length f_{G2} of the second lens group satisfies 0.5<f_{G2}/f_{G1}<2,
the focal length f_{G3} of the third lens group satisfies 10<f_{G1}/f_{G3}<30.

9. The optical adapter device according to claim 7,
wherein the first lens group is a doublet lens group with positive focal power, and
$$\frac{\vert {R}_{1} \vert}{{φ}_{1} / 2} < 20 ,$$
where R₁ is the curvature radius of the cemented surface of the first lens group, and φ₁ is the effective pore size of the cemented surface;
the second lens group is a doublet lens group with positive focal power, and
$$\frac{\vert {R}_{2} \vert}{{φ}_{2} / 2} < 15 ,$$
where R₂ is the curvature radius of the cemented surface of the second lens group, and φ₂ is the effective pore size of the cemented surface;
the third lens group comprises a doublet lens group with positive focal power and a single lens, and
$$\frac{\vert {R}_{3} \vert}{{φ}_{3} / 2} < 10 ,$$
where R₃ is the curvature radius of the cemented surface of the doublet lens group in the third lens group, and φ₃ is the effective pore size of the cemented surface.

10. The optical adapter device according to claim 7, wherein the first lens group is disposed in the first housing segment; the first mirror and the second lens group are disposed in the second housing segment; the second mirror and the third lens group are disposed in the third housing segment.

11. The optical adapter device according to claim 6, wherein the lens group comprises a first lens group and a second lens group located on the first axis, and a third lens group located on the second axis, and the first lens group and the second lens group are disposed in the direction of a light ray.

12. The optical adapter device according to claim 11, wherein
the focal length f_{G1} of the first lens group satisfies −300 mm<fG₁<−150 mm,
the focal length f_{G2} of the second lens group satisfies −2<f_{G2}/f_{G1}<−0.2,
the focal length f_{G3} of the third lens group satisfies: 2<f_{G1}/f_{G3}<20.

13. The optical adapter device according to claim 11,
wherein the first lens group is a doublet lens group with negative focal power, and
$$\frac{\vert {R}_{1} \vert}{{φ}_{1} / 2} < 8 ,$$
where R₁ is the curvature radius of the cemented surface of the first lens group, and φ₁ is the effective pore size of the cemented surface;
the second lens group is a doublet lens group with positive focal power, and
$$\frac{\vert {R}_{2} \vert}{{φ}_{2} / 2} < 15 ,$$
where R₂ is the curvature radius of the cemented surface of the second lens group, and φ₂ is the effective pore size of the cemented surface;
the third lens group is a doublet lens group with negative focal power, and
$$\frac{\vert {R}_{3} \vert}{{φ}_{3} / 2} < 11 ,$$
where R₃ is the curvature radius of the cemented surface of the doublet lens group in the third lens group, and φ₃ is the effective pore size of the cemented surface.

14. The optical adapter device according to claim 11, wherein the first lens group is disposed in the first housing segment; the second lens group, the first mirror and the third lens group are disposed in the second housing segment; the second mirror is disposed in the third housing segment.

15. The optical adapter device according to claim 1, wherein the optical lens group comprises an image steering lens group for adjusting the direction of an optical image imaged on a photosensitive unit of the digital camera device, and the image steering lens group is located on the second axis, and is able to rotate taking the second axis as the axis of rotation.

16. The optical adapter device according to claim 15, wherein the second housing segment is provided with a rotating portion for rotating the image steering lens group, and the image steering lens group is connected to the rotating portion.

17. The optical adapter device according to claim 1, wherein the body housing consists of the first housing segment, the second housing segment and the third housing segment.

18. (canceled)

19. (canceled)

20. A surgical microscope, comprising a microscope body and an optical adapter device, the microscope body comprising a microscope lens body, a splitter and an eyepiece, the splitter being connected to the microscope lens body, the eyepiece and the optical adapter device being respectively connected to the splitter, wherein the optical adapter device is the optical adapter device according to claim 1.

21. The surgical microscope according to claim 20, wherein the surgical microscope further comprises a digital camera device, and the digital camera device is selected from a smart phone, a camera, and a tablet computer, and/or, in at least one state of the surgical microscope, the eyepiece and the digital camera device face the same side of the microscope lens body, and/or, the optical adapter device is detachably connected to the splitter.

22. (canceled)

23. (canceled)

24. The surgical microscope according to claim 20, wherein the splitter comprises a splitter housing and a splitter lens group arranged inside the splitter housing, the splitter housing has a lens body connection end, an eyepiece connection end and an adapter connection end, the eyepiece connection end faces the front side of the microscope lens body, the adapter connection end faces the rear side of the microscope lens body, the microscope lens body is connected to the lens body connection end, the eyepiece is connected to the eyepiece connection end, and the optical adapter device is connected to the adapter connection end.

25. The surgical microscope according to claim 24, wherein the splitter lens group comprises a combination of a pentaprism and a Schmidt prism, or a combination of a cubic prism and a pentaprism, or a combination of a cubic prism, a pentaprism and a rhombic prism, or a combination of a cubic prism, a pentaprism and a right-angle prism, or a combination of a cubic prism, a right-angle roof prism and a right-angle prism.
